(19) United States
(12) Patent Application Publication
(10) Pub. No.: US 2007/0137449 A1
(43) Pub. Date: Jun. 21, 2007

(54) Hexagon and shape cutting template and method of using same

(76) Inventor: Jason William Whaley, Casper, WY (US)

Correspondence Address: FOLEY AND LARDNER LLP;SUITE 500, 3000 K STREET NW, WASHINGTON, DC, 20007, US

(21) Appl. No.: 11/633,089

(22) Filed: Dec. 4, 2006

Related U.S. Application Data
(63) Continuation-in-part of application No. 10/913,824, filed on Aug. 7, 2004.

(51) Int. Cl. B26D 1/00

(52) U.S. Cl. 83/13

(57) ABSTRACT

A cutting template for use in cutting various shapes of various sizes, into or out of a medium. The template can include a sheet with two grooves in the shape of an X that define the edge of a cut shape and markings that define various sizes and permit registration with a medium. The grooves function to guide a cutting instrument that extends through the grooves into the medium to be cut, eliminating any need for tracing a pattern onto the medium. The template can be made of a plastic or similar material sheet that is transparent or translucent to a sufficient degree for a user to see registration markings on the template and the medium upon which the template is placed.

This application is a continuation-in-part of U.S. application Ser. No. 10/913,824, filed on Aug. 7, 2004, which is hereby incorporated by reference in its entirety.

### BACKGROUND

The application relates generally to a device and method for cutting material into selected shapes. More specifically, the application relates to a template and a method of using a template for guiding a cutting instrument for cutting selected materials so as to produce selected shapes.

Many hobbies and professions involve sizing or shaping materials. For example, those who make quilts will often cut textile fabric into shapes prior to sewing them together in a larger conglomeration. Size, registration, and speed all are involved in various degrees in making these shapes. Frequently fabric artists must define the shape onto fabric using a washable pencil or marker.

Unfortunately, methods involving marking on fabric with a washable pencil or marker are laborious and exceedingly time-intensive. Similarly, current devices available to speed this process along are time-intensive, and do not easily allow for “in-between” sizes, wherein a specific intended size of shape is smaller or larger than the current template design allows.

What is needed is a device and method that addresses accuracy of registration, great variation in size of final shape, and the speed to complete these tasks with a minimum of labor intensiveness and time. This invention seeks to eliminate the marking step in favor of a significantly faster registration process and method, and represents achievements over and above those currently available which demonstrate a lacking in the art of shape cutting. Additionally, this device allows for the near-infinite use of “in-between” sizes in comparison to devices currently in the public use and domain.

### SUMMARY OF THE INVENTION

According to an embodiment, a template for cutting a medium into a predetermined shape comprises a sheet; a pair of cutting grooves adapted to receive and maintain a cutting implement for cutting the medium, wherein the cutting grooves are formed in the shape of an X; and registration marks for locating said template relative to the medium; wherein the cutting grooves each have a width sufficient to restrict lateral movement of the cutting implement within the grooves.

According to an embodiment, a template for cutting a medium into a predetermined shape comprises a sheet; a pair of cutting grooves adapted to receive and maintain a cutting implement for cutting the medium, wherein the cutting grooves are formed in the shape of an X; and registration marks for locating said template relative to the medium; wherein the registration marks are arranged at a calibrated distance from a center of the X, wherein the calibrated distance corresponds to a size of the predetermined shape.

According to an embodiment, a method for cutting a medium into a predetermined shape, comprises the steps of (a) providing a template according any of the embodiments described herein, (b) positioning said template over or upon the medium; (c) inserting a cutting implement into one cutting groove; (d) drawing the cutting implement across the medium sufficiently to make a complete cut; and (e) repeating steps C and D or repositioning said template relative to the medium before repeating steps C and D.

It is to be understood that both the foregoing general description and the following detailed description are exemplary and explanatory only, and are not restrictive of the invention as claimed.

### BRIEF DESCRIPTION OF THE DRAWING

These and other features, aspects, and advantages will become apparent from the following description, appended claims, and the accompanying exemplary embodiments shown in the drawings, which are briefly described below.

FIG. 1 depicts a top perspective view of an embodiment such that it may be discerned in three dimensions, and generally from the user's line of sight.

FIG. 2 depicts a top view of an embodiment.

FIG. 3 depicts a top view showing a step of cutting a hexagon shape, according to an embodiment.

FIG. 4 depicts a top view showing a step of cutting a hexagon shape, according to an embodiment.

FIG. 5 depicts a top view showing a step of cutting a hexagon shape, according to an embodiment.

FIG. 6 depicts a top view showing a step of cutting a hexagon shape, according to an embodiment.

FIG. 7 depicts a top view showing a step of cutting a hexagon shape, according to an embodiment.

FIG. 8 depicts a top view showing a step of cutting a hexagon shape, according to an embodiment.

FIG. 9 depicts a top view showing a step of cutting a triangle shape, according to an embodiment.

FIG. 10 depicts a top view showing a step of cutting a triangle shape, according to an embodiment.

FIG. 11 depicts a top view showing a step of cutting a triangle shape, according to an embodiment.

FIG. 12 depicts a top view showing a step of cutting a triangle shape, according to an embodiment.

FIG. 13 depicts a top view showing a step of cutting a triangle shape, according to an embodiment.

FIG. 14 depicts a top view showing a step of cutting a triangle shape, according to an embodiment.

FIG. 15 depicts a top view showing a step of cutting a triangle shape, according to an embodiment.

FIG. 16 depicts a top view showing a step of cutting a triangle shape, according to an embodiment.

FIG. 17 depicts a top view showing a step of cutting a triangle shape, according to an embodiment.

FIG. 18 depicts a top view showing a step of cutting a diamond shape, according to an embodiment.

FIG. 19 depicts a top view showing a step of cutting a diamond shape, according to an embodiment.

FIG. 20 depicts a top view showing a step of cutting a diamond shape, according to an embodiment.

FIG. 21 depicts a top view showing a step of cutting a diamond shape, according to an embodiment.

FIG. 22 depicts a top view showing a step of cutting a diamond shape, according to an embodiment.

FIG. 23 depicts a top view showing a step of cutting a diamond shape, according to an embodiment.

FIG. 24 depicts a top view showing a step of cutting a trapezoid shape, according to an embodiment.

FIG. 25 depicts a top view showing a step of cutting a trapezoid shape, according to an embodiment.

FIG. 26 depicts a top view showing a step of cutting a trapezoid shape, according to an embodiment.

FIG. 27 depicts a top view showing a step of cutting a trapezoid shape, according to an embodiment.

FIG. 28 depicts a top view showing a step of cutting a trapezoid shape, according to an embodiment.

FIG. 29 depicts a top view showing a step of cutting a trapezoid shape, according to an embodiment.

FIG. 30 depicts a top view showing a step of cutting a gemstone shape, according to an embodiment.

FIG. 31 depicts a top view showing a step of cutting a gemstone shape, according to an embodiment.

FIG. 32 depicts a top view showing a step of cutting a gemstone shape, according to an embodiment.

FIG. 33 depicts a top view showing a step of cutting a gemstone shape, according to an embodiment.

FIG. 34 depicts a top view showing a step of cutting a gemstone shape, according to an embodiment.

FIG. 35 depicts a top view showing a step of cutting a gemstone shape, according to an embodiment.

FIG. 36 depicts a top view showing of a template and polygon shapes cut with the template, according to an embodiment.

### DETAILED DESCRIPTION OF THE INVENTION

A cutting template of unique design is provided for use in cutting a selected medium or material in sheet form so as to create a selected pattern or shape. For example, the template can be used to cut a hexagon, trapezoid, triangle, diamond, or gemstone of a predetermined size. The invention also provides a method of using such templates so as to cut selected shapes in a selected medium. The template can be used to cut out pieces of selected shapes and sizes for mounting on a separate substrate. The template also allows for a wide range of sizes to be cut out of a selected medium. The template can be made of a transparent or translucent plastic, polycarbonate or similar material which allows for visual placement of template relative to medium for specific accurate registration during alignment and cutting of medium. The template can include cutting grooves that guide a cutting blade so as to assure precision cutting. It will also be apparent that greatly increased speed of cutting is achieved by use of this invention as compared to conventional devices and methods.

According to an embodiment, a device is provided for guiding a cutting instrument that cuts selected materials so as to produce selected shapes. The device can be a template made of a plastic material. For example, the template can be made of a plastic that is sufficiently clear to allow the user to read the registration marks and see the material to be cut below it. The template can be made from a variety of types of plastic material (such as, for example, acrylic, polycarbonate, and other suitable clear plastic materials). The template can be made by various methods of manufacture, which can be specific to the manufacturer of the product selected. According to an embodiment, the template can be made by computer-numerically-controlled and/or laser machining of planar plastic sheets, or by standard injection molding practices. For example, the “front” side (that which the user faces directly during use) is typically milled by a Computer Numercial Control (CNC) machine, so as to cut the beveled grooves of the template's pattern. According to an embodiment, the indicia for registration and measurement can be engraved or laser etched into the back side of the substrate to minimize parallax for the end user. The CNC mill and/or laser is directed with an electronic document or similar file and operated per the functions of the mill or laser engraving device.

Conventional methods used for marking and cutting hexagons and similar shapes (trapezoids, triangles) typically involve one of two methods. The first method uses a plastic stencil. The user lays the stencil upon the fabric, marks the fabric with a pencil, chalk or pen (typically of a material that washes away), and does this repeatedly for the number of shapes needed; the user then cuts the fabric using any available means (scissors, rotary cutter, etc), and sets aside the usable shapes needed. The second method involves solid outline shapes, of hexagons, trapezoids, triangles, etc., typically made of a plastic material. Using this method, the user lays the solid shape upon the fabric and cuts it out directly with a rotary cutter, or marks the fabric as previously described and cuts it with any available means. Both of these steps are very laborious—they cannot easily make cuts through several layers with accurate registration, they can be wasteful, they cannot account for sizes other than those exactly provided by their methods (“in-between sizes”), and they take significant time to perform the multitude of steps.

This device eschews multiple labor steps in favor of a brisk registration and cutting process. By providing accurate registration and removing the marking step, this allows the end user to cut through a number of layers of underlying fabric at once when using a rotary knife. By removing the marking step and allowing multiple layers to be cut at once, the time required to cut shapes sufficient for one's project may be quite radically reduced. This could also reduce activity-related strain due to time spent on activity, provided the ergonomics of the user's workstation are functional to such a degree. Furthermore, embodiments described herein permit shapes to be repeatedly cut with accurate size. The ability to repeatedly cut accurately sized shapes is an important consideration for users. For example, the quilting art requires a user to repeatedly cut different shapes and join them together to attain a desired final design. If the cut shapes are not accurate in size and/or shape, an error is created. Even if this error is small, the error will accumulate and grow as subsequent shapes are cut and the individual errors for each cut shape are compounded with one another when they are joined. Therefore, there is a need to accurately and repeatedly cut various shapes.

The device can be used to cut a variety of shapes of various sizes with rapid and accurate registration. Due to the unique shape of the device, a method can be implemented so the user can become familiar with the operation of the device. For example, various methods are described below for cutting hexagons, triangles, diamonds, trapezoids, and gemstones.

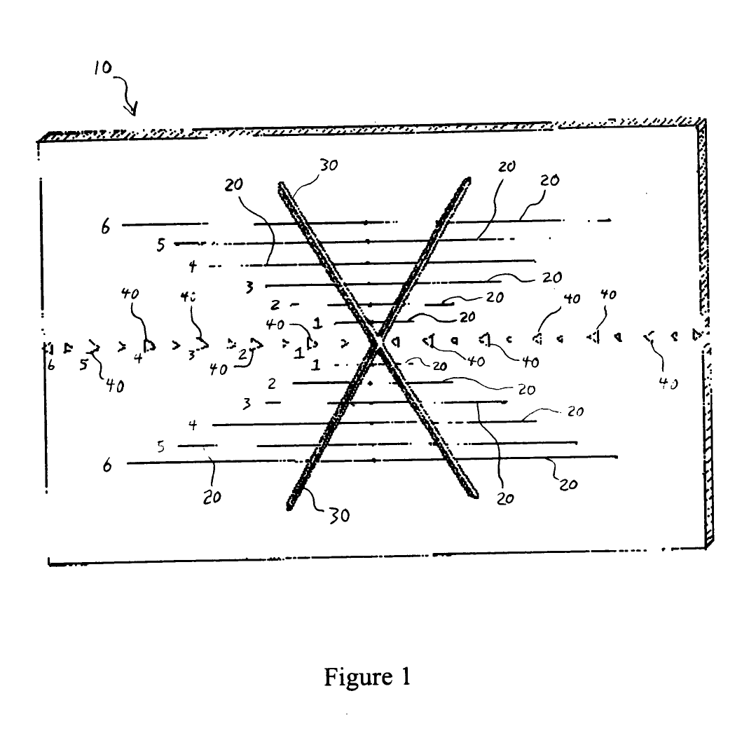

FIG. 1 depicts a top perspective view of a template 10, according to an embodiment. As shown in the example of FIG. 1, the template 10 can be a sheet that includes registration lines 20 and channels or grooves 30 for a cutting implement, such as a rotary cutter. Channels or grooves 30 can be arranged in the shape of an “X,” as shown in FIG. 1. The grooves 30 are preferably configured so that the grooves 30 pass completely through the template 10, permitting a user to cut a medium, such as a fabric, disposed beneath the template 10. Grooves 30 can be beveled to facilitate placement of a cutting implement within the grooves 30. According to a further embodiment, grooves 30 are the only grooves in the template.

According to an embodiment, cutting grooves 30 are of sufficient width to constrain lateral movement of a cutting implement. For example, the grooves 30 can be of sufficient width to constrain lateral movement of a rotary cutter. If the cutting grooves 30 are too wide, a cutting implement will be able to move or wander in a direction lateral to a cutting direction, thus introducing error in the shape and/or size that is cut. According to another embodiment, cutting grooves 30 are configured so that a cutting implement snugly fits within the cutting grooves 30 to control lateral movement of the cutting implement. According to another embodiment, cutting grooves 30 each have a width sufficient to restrict lateral movement of a cutting implement within the cutting grooves 30. According to another embodiment, cutting grooves 30 each have a width such that, when a cutting implement is in one of the cutting grooves 30, the cutting implement can move only in a forward-rearward direction and not in a lateral direction. According to another embodiment, cutting grooves 30 are substantially the same width as a cutting implement. For example, cutting grooves 30 can be substantially the same width as a rotary cutter.

According to a further embodiment, grooves 30 can be formed in the shape of an “X” by forming two acute two acute angles of 60 degrees and two obtuse angles of 120 degrees between the cutting grooves 30. Such angles advantageously permit a user to cut a properly desired shape, such as a hexagon, in an accurate, repeatable fashion.

Registration lines 20 can be continuous, uninterrupted lines or a series of discontinuous indicia generally arranged in a linear direction. As shown in the example of FIG. 1, registration lines 20 can be arranged to be parallel to one another. Furthermore, registration lines 20 can be arranged in parallel sets that are centered about the point that channels or grooves 30 intersect one another. For example, registration lines 20 can be arranged in pairs that are symmetrically arranged about the center of the X formed by grooves 30. According to a further embodiment, registration lines 20 can be arranged to extend from the grooves 30.

According to an embodiment, registration lines 20 are calibrated to correspond to various sizes of desired shapes. For example, registration lines 20 can be arranged to be a calibrated distance from the center of the X formed by grooves 30. In a further example, sets of registration lines 20 can be arranged to be a calibrated distance from the X on each side of the X formed by the grooves 30.

As shown in the example of FIG. 1, the template 10 can include registration triangles or points 40. Registration triangles 40 can be used to locate and align the template 10 with respect to a medium. For example, registration triangles 40 can be used to locate and align the template 10 with respect to a medium that has been cut using grooves 30.

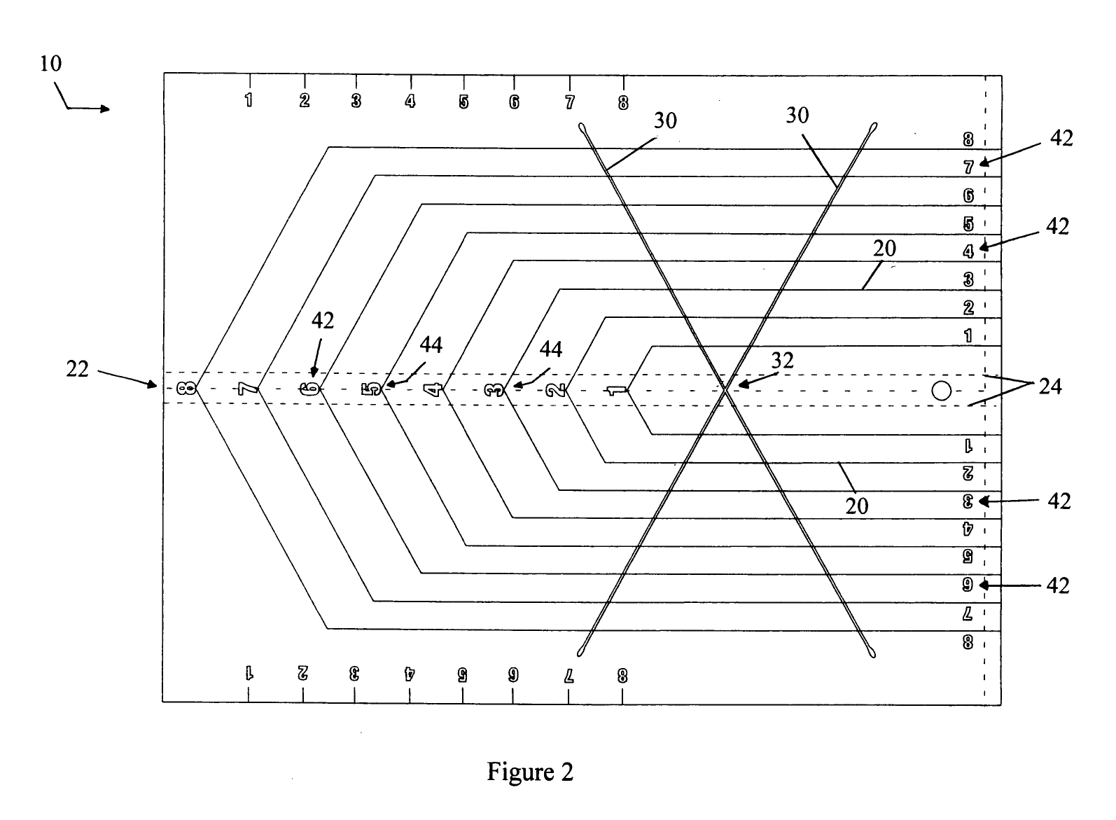

FIG. 2 shows a top view of a template 10, according to an embodiment. The template 10 can be a sheet that includes registration lines 20 and channels or grooves 30 for a cutting implement, such as a rotary cutter. Registration lines 20 and grooves 30 can have the characteristics of any embodiments described herein. Grooves 30 can be arranged to form an “X,” with a center of the “X,” which is also the point where the grooves 30 intersect, as depicted in FIG. 2 as numeral 32. The template 10 can include a center line 22 that passes through the center 32 of the X. As shown in the example of FIG. 2, the center line 22 can be a discontinuous linear arrangement of any type of indicia or the center line 22 can be a continuous line.

As shown in the example of FIG. 2, template 10 can include registration points 44. Registration points 44 correspond to registration triangles 40 shown in the example of FIG. 1. For example, registration points 44 can be used to locate and align the template 10 with respect to a medium, such as, for example, a medium that has been cut by using grooves 30.

The template 10 can include size indicia 42 to indicate a relative size that will be produced by a medium that is aligned with registration lines 20 and/or registration points 44. According to an embodiment, size indicia 42 do not indicate an actual size of a cut shape, but instead indicate a relationship to a size of a cut shape. For example, a size indicia 42 may correspond to a long axis of a cut shape.

According to a further embodiment, a template 10 can include off-size registration lines 24, which permit a user to align the template 10 with the medium to cut sizes that fall in between those corresponding to registration lines 20. For example, a template 10 can be aligned with a medium so that one edge of the medium is aligned with an off-size registration line 24 and another edge of the medium is aligned with a registration line 20. A template 10 can include additional off-size registration lines than those indicated in the example of FIG. 2. For example, a template 10 can include off-size registration lines located between any of registration lines 20.

According to an embodiment, a method of cutting hexagons is provided. First, the user must predetermine the size of the hexagon, which is intended for their needs. For the purposes of an example, a three inch (3″) hexagon will be discussed, although hexagons of varying sizes may be cut using this embodiment.

According to this embodiment, the user must cut strips of the selected medium that correspond with the “3” line 20 on the template 10. This is not truly three inches, rather it is a width determined by the ratio of the maximum length to minimum width of a hexagon, the “3” definition is the long axis of the hexagon, which will be greater than the short axis, which is the reference for width in this case. When the strips are cut, they are laid in a horizontal fashion on a table or similar surface so that they may be cut. Ideally a mat, which prevents cutting of the underlying table, could be used, but this is to be determined by the user based upon their needs. The template 10 is laid upon the strips, and the strips are registered between the “3” lines 20 on the template. The template 10 is slid down to one end, and the center of the fabric strip is placed in the center of the “X” formed by cutting grooves 30. Cuts are then made with a cutting implement, using the cutting grooves 30 to cut the end of the strip into a broad point. The template 10 is then moved laterally until the center of the broad point that had just been cut is now placed on the point of the registration triangle 40 or a registration point 44 marked with a “3”. This movement ensures accurate distance of the long axis of the hexagon. The cutting implement is then brought back into contact with the specified medium through the cutting grooves 30, and the medium is cut. This will serve two functions—one, it will cut free a hexagon from the specified medium; two, it will form another broad point for registering the next hexagon as the first one was registered. The process is then repeated—align the broad point with the “3” triangle registration mark 40 or registration point 42, and cut the medium again. Multiple layers of medium may be cut simultaneously to improve speed, provided the cutting implement may be pushed through them, and the user is safe in doing so. Other sizes may be cut using this template 10, substituting the “3” used in the example above with the necessary size or fractional size required by the needs of the user.

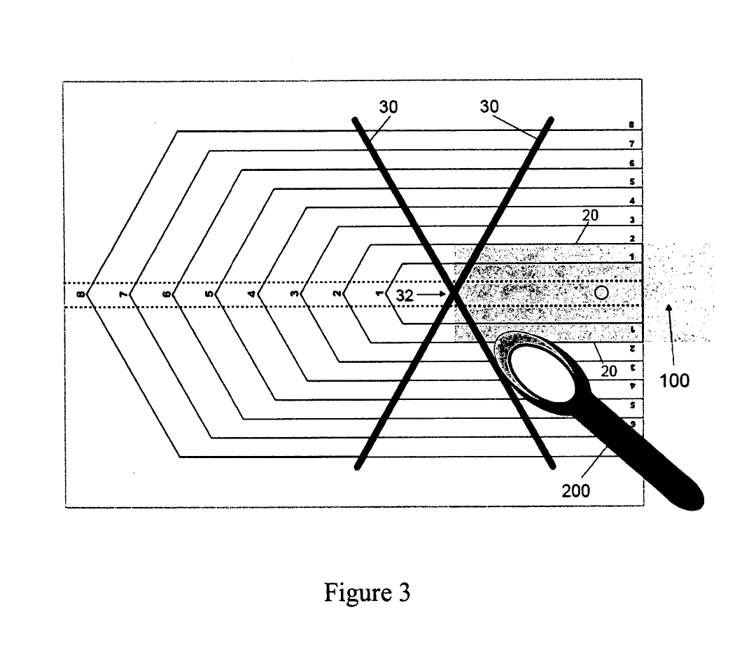

According to another embodiment, a method of cutting hexagons is provided, as shown in the examples of FIGS. 3-8. The template depicted in FIGS. 3-8 can have any features of the template embodiments described herein. FIGS. 3-8 depict exemplary steps of cutting a hexagon from a medium 100 that is disposed underneath a template. As shown in FIG. 3, a template is initially disposed on top of a medium 100 so that the medium is located and aligned between registration lines 20 and so that a leading edge of the medium is aligned with the center 32 of the X. In the example shown in FIG. 3, the medium is arranged between registration lines 20 with “2” size indicia 42. However, a medium 100 can be arranged between registration lines 20 of other size indicia 42 or between off-size registration lines 24.

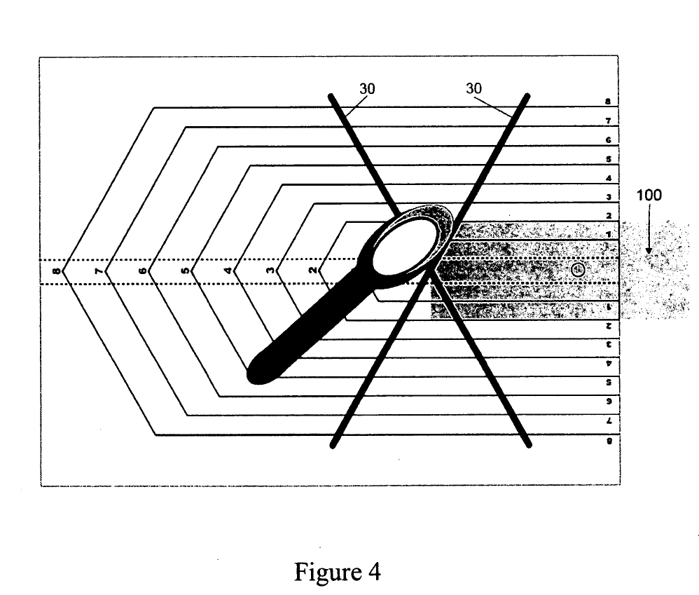

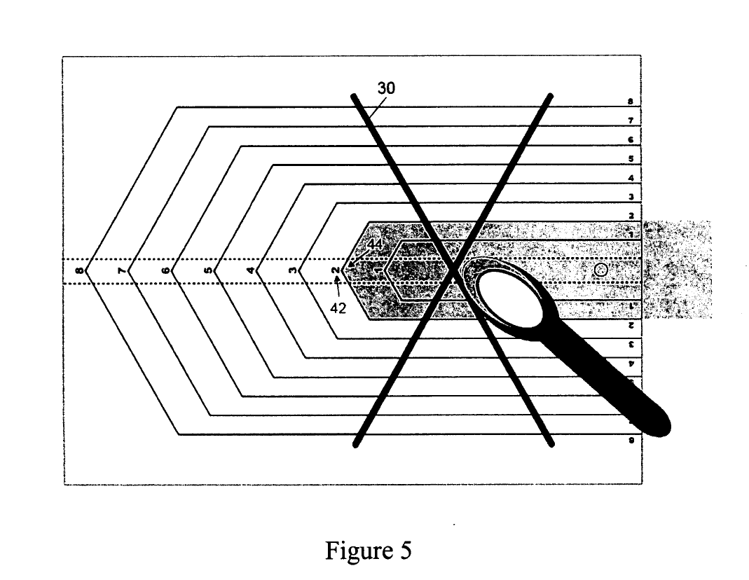

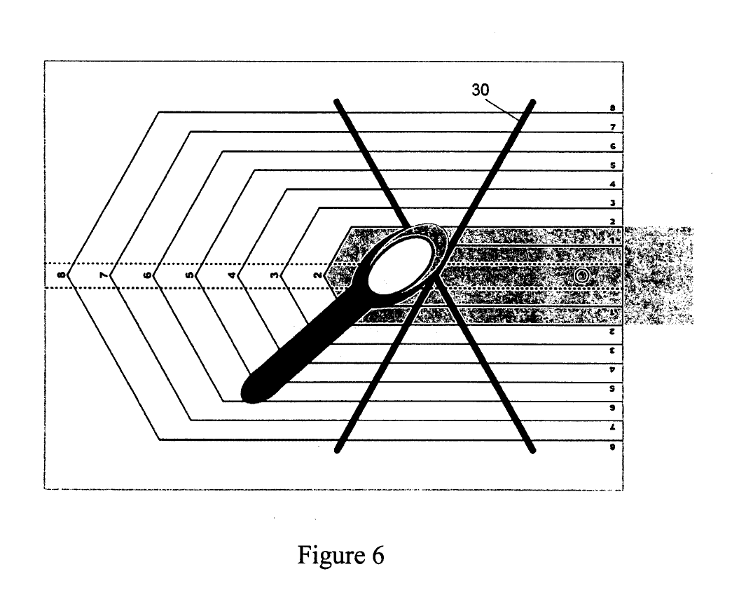

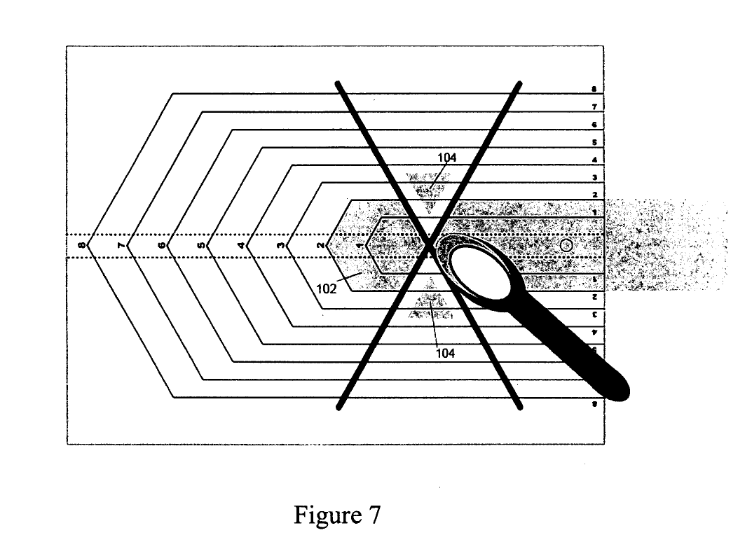

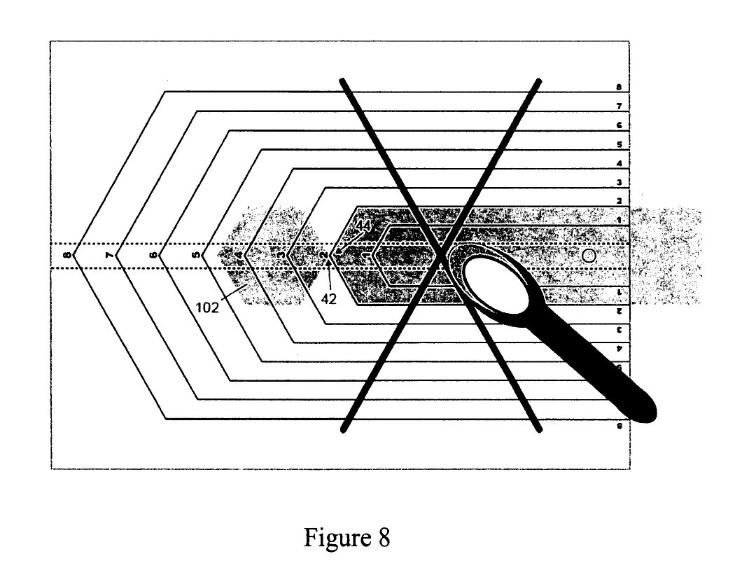

At this point, the medium 100 and template are prepared for cutting with a cutting implement, such as a rotary cutter 200. As shown in FIG. 4, the rotary cutter 200 is drawn along both grooves 30 to provide two cuts in medium 100 that form a broad point on the leading edge of the medium 100. As shown in FIG. 5, the template is then moved relative to the medium 100 so that the broad point cut into the medium is now located and aligned with registration point 44. In the example of FIG. 5, the broad point of the medium 100 is located with the registration point 44 having a sized indicia 42 of “2,” which corresponds to the size indicia of the registration lines 20 that the medium 100 is aligned between. Once the medium has been aligned in this manner, the medium is once again cut along both grooves 30, as indicated in FIGS. 5 and 6. These cuts along grooves 30 provide a hexagon shape 102 and two triangular pieces 104, as shown in FIG. 7. The two cuts also provide another broad point on the leading edge of medium 100, permitting the steps shown in FIGS. 5-7 to be repeated to make further hexagon shapes 102 and triangular pieces 104. As depicted in FIG. 8, the template can be shifted so that the broad point of medium 100 is once again located at a registration point 44 and another hexagon shape 102 can be cut.

According to an embodiment, a method of cutting equilateral triangles is provided. The user first predetermines the size of the triangle which is intended for their needs.

The user cuts strips of the selected medium that correspond with the line 20 on the template 10 and the center of the “X” defined by the cutting grooves 30; specifically, the true size of the triangle will be half the number represented by the registration mark (e.g., a 3″ triangle will correspond to the “6” registration mark). This discrepancy between the intended size and the registration line 20 number is required due to the triangle being half the width of the intended hexagonal shape for which this template is primarily defined. When the strips are cut, they are laid horizontally on a table or similar surface to be cut. Ideally a mat preventing cutting of the underlying table could be used, but this is to be determined by the user based upon their needs. The template 10 is laid upon the strips, and the strips are registered between the registration line 20 and the center of the “X” formed by the cutting grooves 30. The template 10 is then slid down to one end, and cuts are made using a cutting implement through the cutting grooves 30. A right triangle of the specified medium will be formed from the first cut which can be discarded if not useful to the user. The template 10 is then moved laterally until the bottom edge of the now-cut triangle is just touching the bottom of the opposite cutting groove 30 (e.g., the ‘left’ side of the triangle is now touching the ‘right’ cutting groove 30). This movement ensures accurate distance of the side of the triangle. The cutting implement is then brought back into contact with the specified medium through the cutting grooves 30, and the medium is cut. This will serve two functions—one, it will cut free a pair of triangles from the specified medium, and, two, it will form another edge for the next triangle as the first one was registered. The process is then repeated—align the cut edge of the triangle with the opposite cutting groove, and cut the medium again. Multiple layers of medium may be cut simultaneously to improve speed, provided the cutting implement may be pushed through them, and the user is safe in doing so. Other sizes may be cut using this template 10, substituting the “6” used in the example above with the necessary size or fractional size required by the needs of the user.

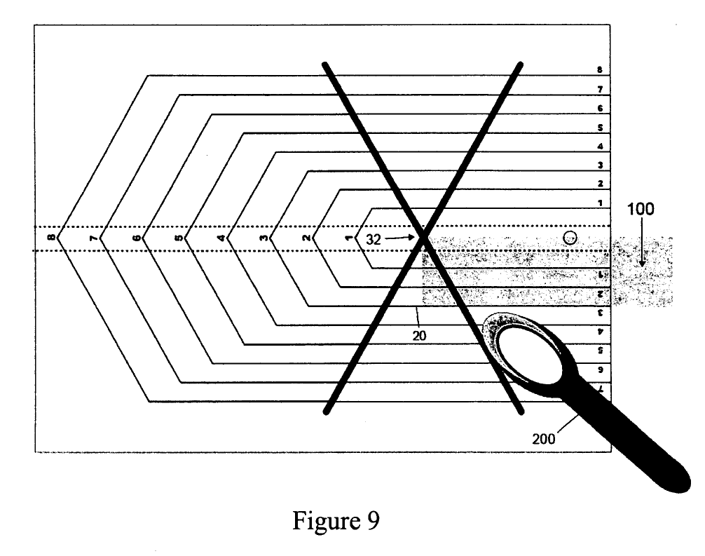

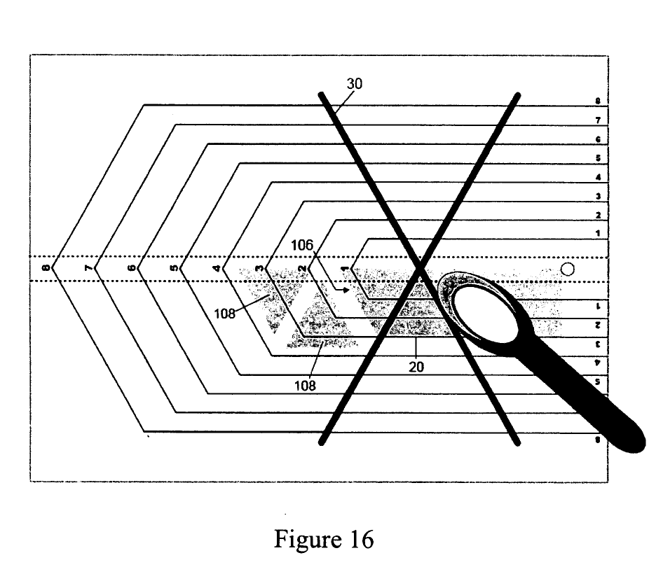

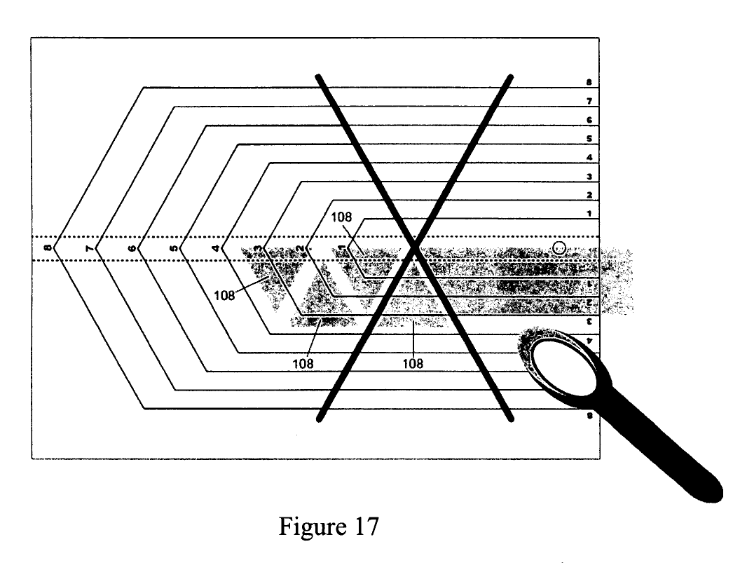

According to another embodiment, a method of cutting triangles, such as equilateral triangles, is provided, as shown in the examples of FIGS. 9-17. The template depicted in FIGS. 9-17 can have any features of the template embodiments described herein. FIGS. 9-17 depict exemplary steps of cutting a triangle from a medium 100 that is disposed underneath a template. As shown in FIG. 9, a template is initially disposed on top of a medium 100 so that the a corner of the medium 100 is located and aligned at the center 32 of the X and a distal edge of the medium 100 is located and aligned with a registration line 20. According to an embodiment, an edge of the medium can be aligned with a center line 22 of the template that passes through the center 32 of the X, as shown in the example of FIG. 2. As shown in the example of FIG. 9, the medium 100 can be aligned with a registration line 20 with a size indicia 42 of “3.” However, a medium 100 can be aligned with a registration line 20 with another size indicia 42 or with an off-size registration line 24.

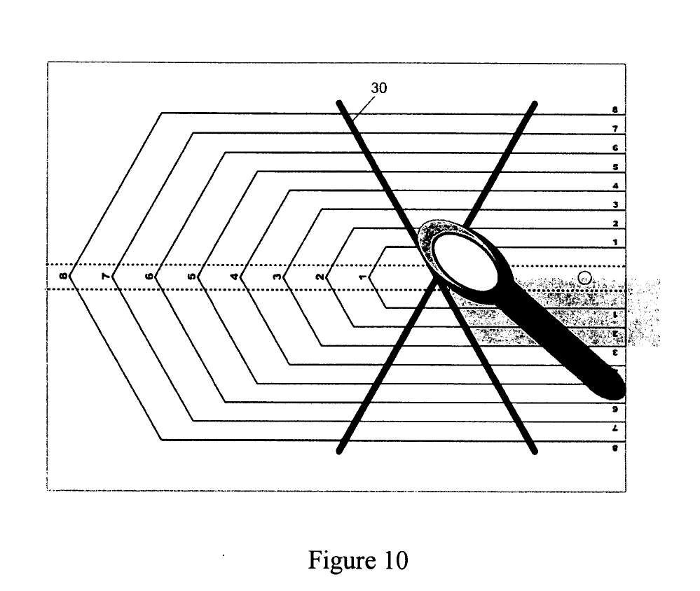

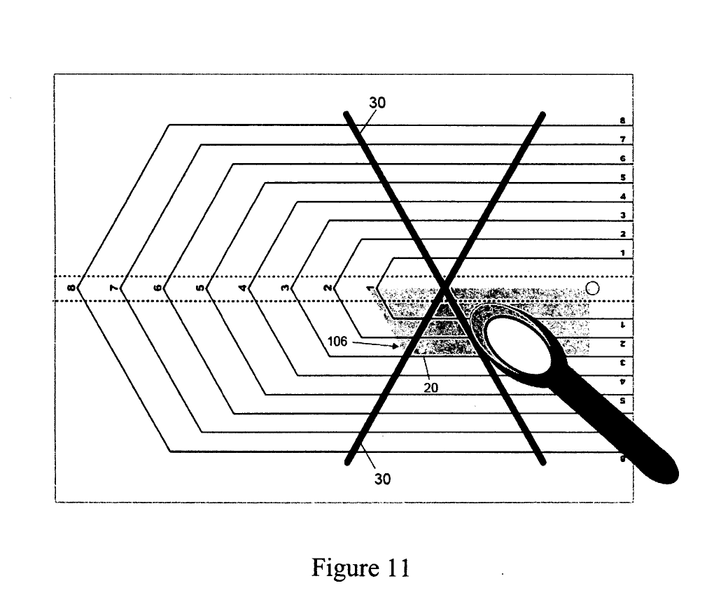

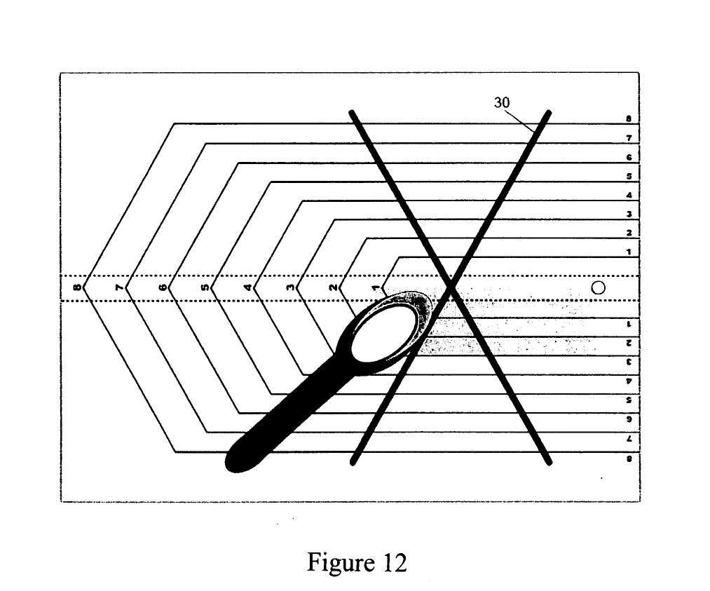

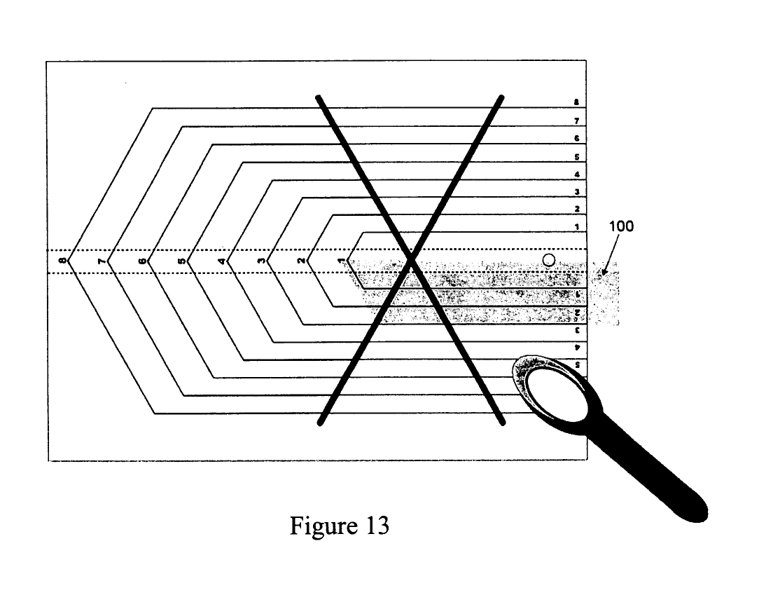

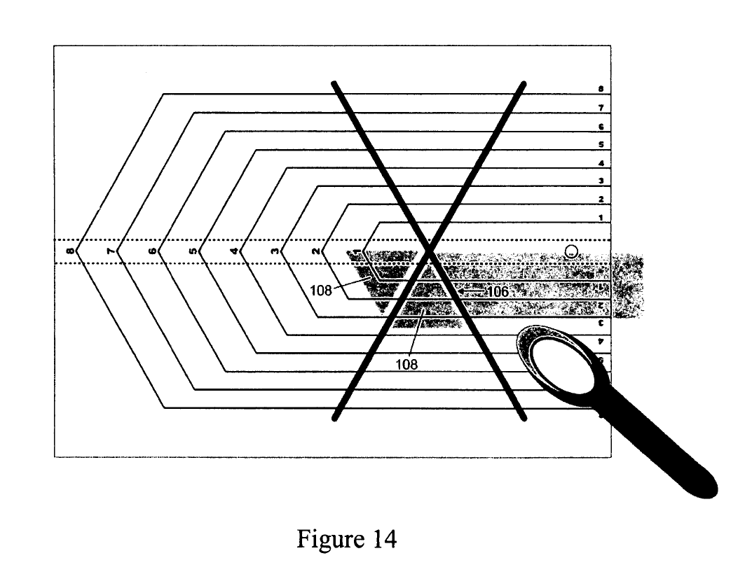

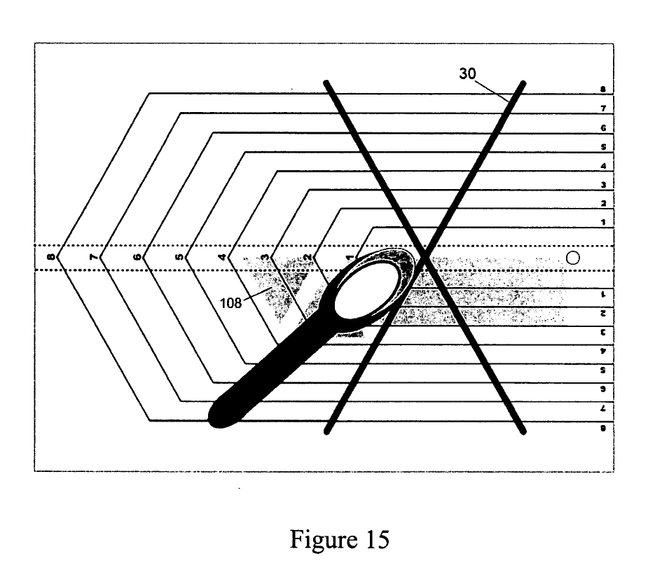

At this point, the medium 100 and template are prepared for cutting with a cutting implement, such as a rotary cutter 200. As shown in FIG. 10, the rotary cutter 200 is drawn along groove 30 to make a first cut in the medium. This first cut produces a cut edge 106 in the medium, as depicted in FIG. 11. The template is then located and aligned with the medium so that an end of the cut edge 106 is aligned with a groove 30 near registration line 20. The rotary cutter 200 is then drawn along groove 30 that is parallel to cut edge 106, as shown in FIG. 11. The rotary cutter 200 is subsequently drawn along the other groove 30, as shown in FIG. 12, to make an additional cut in the medium and the rotary cutter 200 can be set aside, as shown in FIG. 13. These cuts produce two triangular shapes 108, as shown in FIG. 14. Furthermore, the medium has a new cut edge 106, permitting the steps of FIGS. 11 and 12 to be repeated to produce additional triangular shapes 108. For example, the template can be located and aligned with the medium so that the cut edge 106 is aligned with a groove near registration line 20, as in the example of FIG. 11. As depicted in FIGS. 15-17, rotary cutter 200 can be drawn along grooves 30 to cut the medium and produce additional triangular shapes 108.

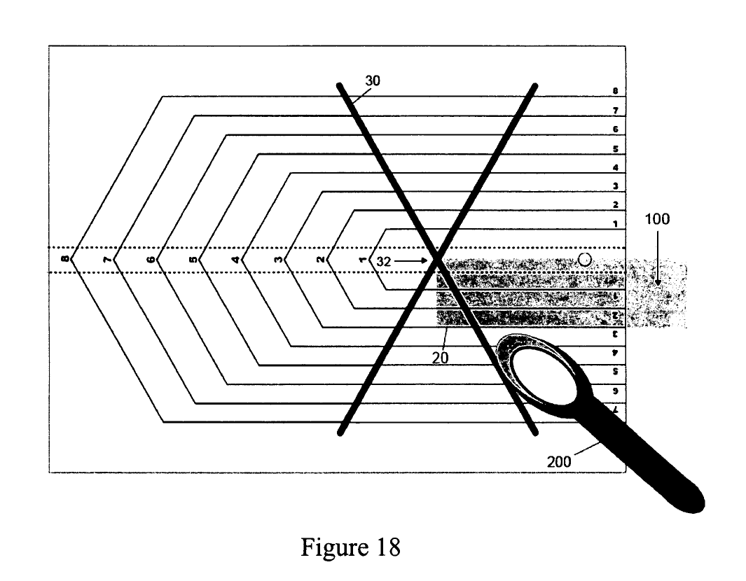

According to another embodiment, a method of cutting diamonds is provided, as shown in the examples of FIGS. 18-23. The template depicted in FIGS. 18-23 can have any features of the template embodiments described herein. FIGS. 18-23 depict exemplary steps of cutting a diamond from a medium 100 that is disposed underneath a template. As shown in FIG. 9, a template is initially disposed on top of a medium 100 so that the a corner of the medium 100 is located and aligned at the center 32 of the X and a distal edge of the medium 100 is located and aligned with a registration line 20. According to an embodiment, an edge of the medium can be aligned with a center line 22 of the template that passes through the center 32 of the X, as shown in the example of FIG. 2. As shown in the example of FIG. 18, the medium 100 can be aligned with a registration line 20 with a size indicia 42 of “3.” However, a medium 100 can be aligned with a registration line 20 with another size indicia 42 or with an off-size registration line 24.

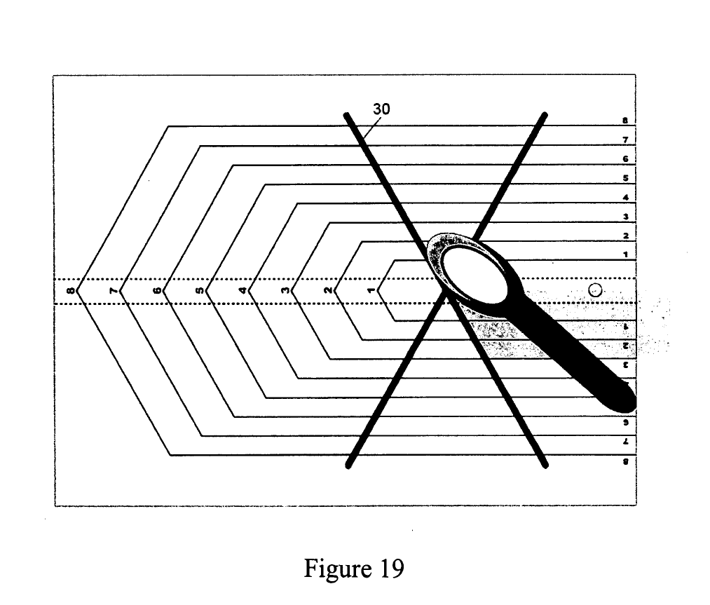

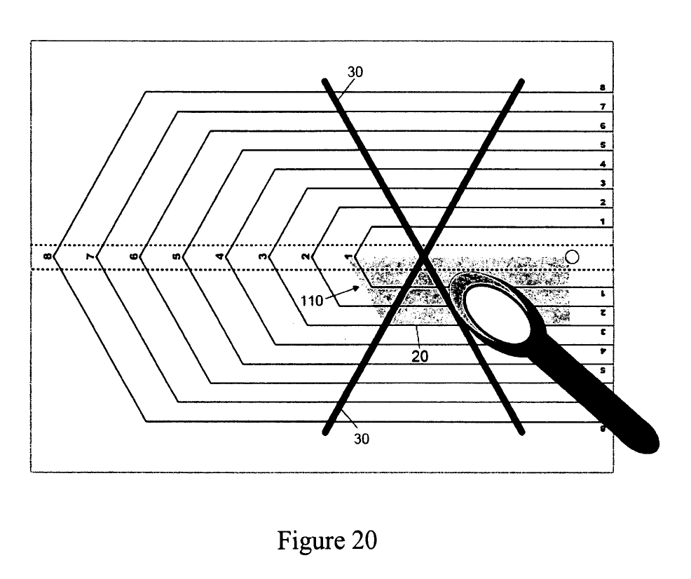

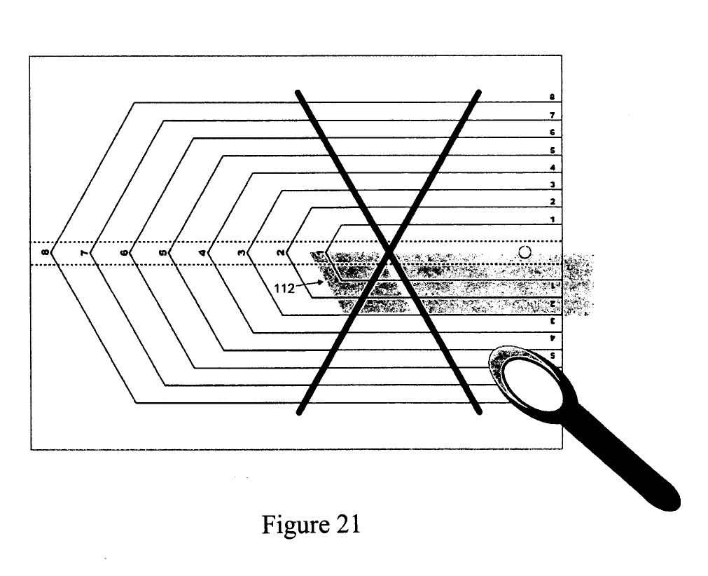

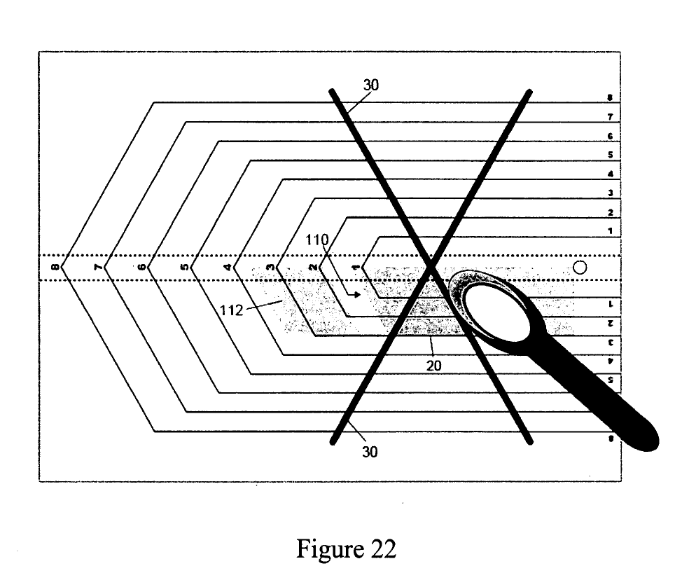

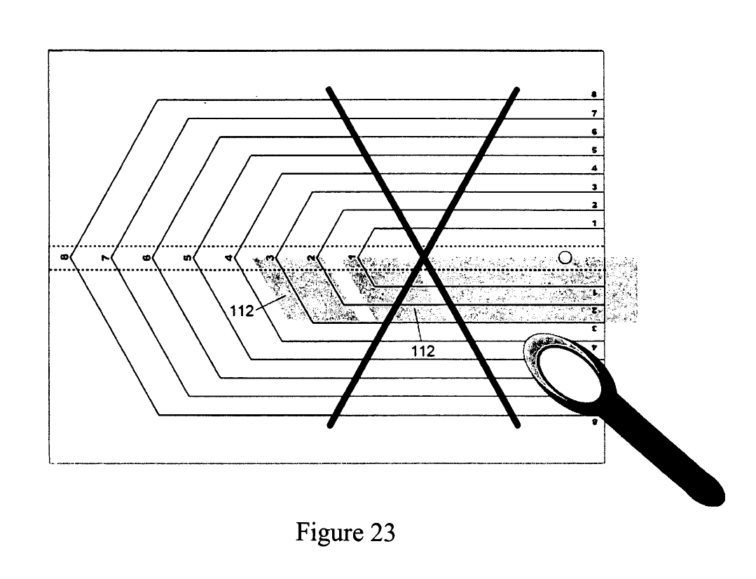

The medium is then cut with a cutting implement, such as a rotary cutter 200. As depicted in FIG. 19, the medium is first cut by drawing the rotary cutter 200 along groove 30. As shown in FIG. 20, the first cut produces a cut edge 110. The template is then located and aligned with the medium so that an end of the cut edge 110 is aligned with a groove 30 near registration line 20, as depicted in the example of FIG. 20. The rotary cutter 200 is then drawn along the groove 30 that is parallel to the cut edge 110 to produce a diamond shape 110, as depicted in FIG. 21. This cut also produces a cut edge 110 in the medium, permitting the steps of FIGS. 20 and 21 to be repeated to produce additional diamond shapes 110. As shown in FIGS. 22 and 23, the cut edge 110 can be aligned with a groove 30 near registration line 20 and the rotary cutter 200 can be drawn along the groove 30 that is parallel to the cut edge 110 to produce an additional diamond shape 110.

According to an embodiment, a method of cutting trapezoids is provided. The user provides strips of a preferred medium to be cut into trapezoid shapes. When the strips are cut, they are laid in a horizontal fashion on a table or similar surface to be cut. Ideally a mat preventing cutting of the underlying table could be used, but this is to be determined by the user based upon their needs. The template 10 is laid upon the strips, and the strips are registered between the preferred registration lines 20. The template 10 is slid down to one end, and the center of the fabric strip is placed in the center of the “X” formed by the cutting grooves 30. Cuts are then made with a cutting implement using the cutting grooves to cut the end of the strip into a broad point. The template 10 is then moved laterally until the top and bottom edges of the cuts that had been made are just within the area defined by the cutting groove 30. This movement ensures accurate distance of the short axis of the trapezoid. The cutting implement is then brought back into contact with the specified medium through the cutting grooves 30, and the medium is cut. This will serve two functions—one, it will cut free a trapezoid from the specified medium, and, two, it will form another broad point for registering the next trapezoid as the first one was registered. The process is then repeated by aligning the top and bottom edges of the now-cut medium with the edge of the cutting groove 30, and cutting the medium again. Multiple layers of medium may be cut simultaneously to improve speed, provided the cutting implement may be pushed through them, and the user is safe in doing so.

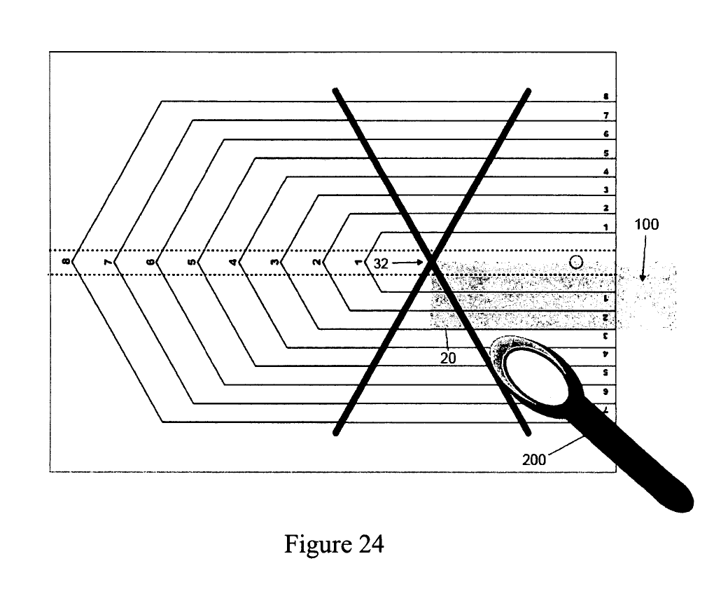

According to another embodiment, a method of cutting trapezoids is provided, as shown in the examples of FIGS. 24-29. The template depicted in FIGS. 24-29 can have any features of the template embodiments described herein. FIGS. 24-29 depict exemplary steps of cutting a trapezoid from a medium 100 that is disposed underneath a template. As shown in FIG. 24, a template is initially disposed on top of a medium 100 so that a corner of the medium 100 is located and aligned at the center 32 of the X and a distal edge of the medium 100 is located and aligned with a registration line 20. According to an embodiment, an edge of the medium can be aligned with a center line 22 of the template that passes through the center 32 of the X, as depicted in the example of FIG. 2. As shown FIG. 24, the medium 100 can be aligned with a registration line 20 with a size indicia 42 of “3.” However, a medium 100 can be aligned with a registration line 20 with another size indicia 42 or with an off-size registration line 24.

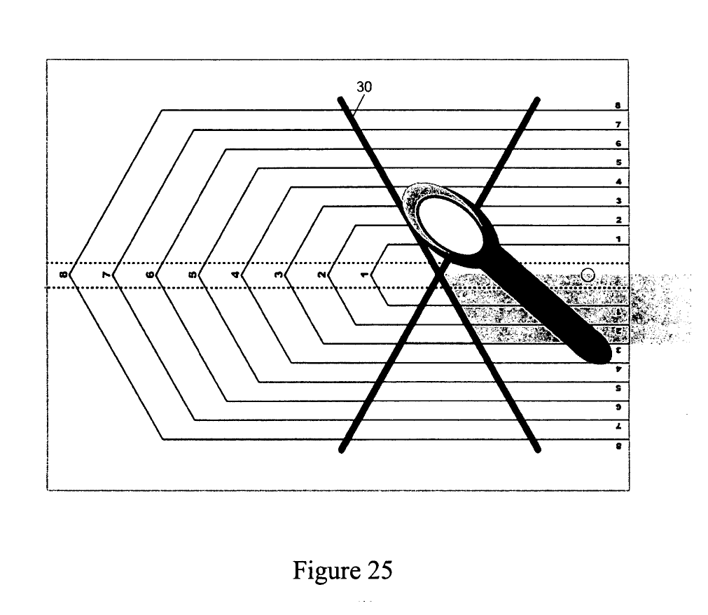

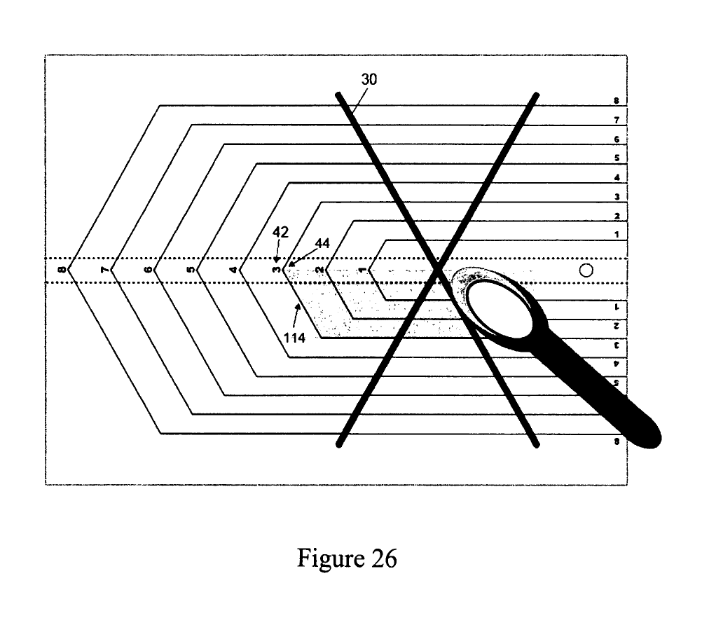

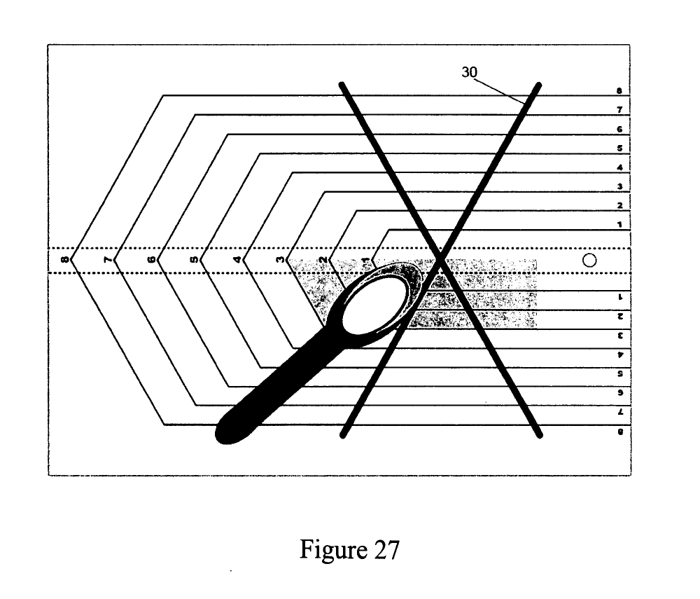

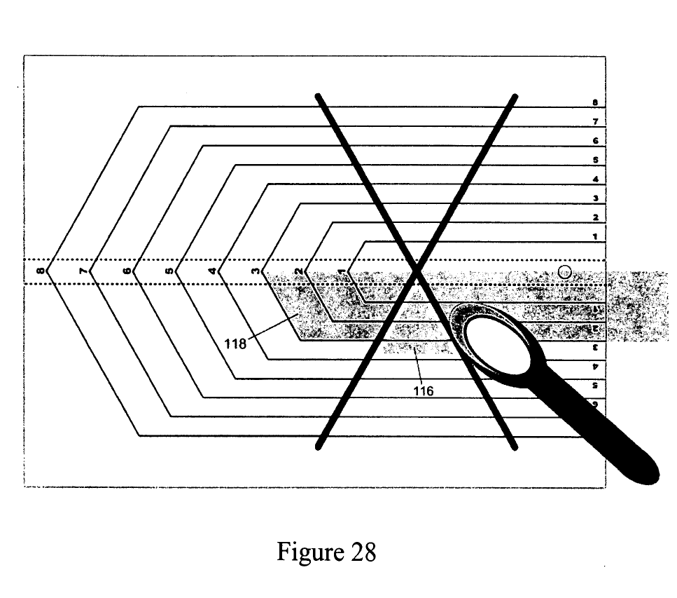

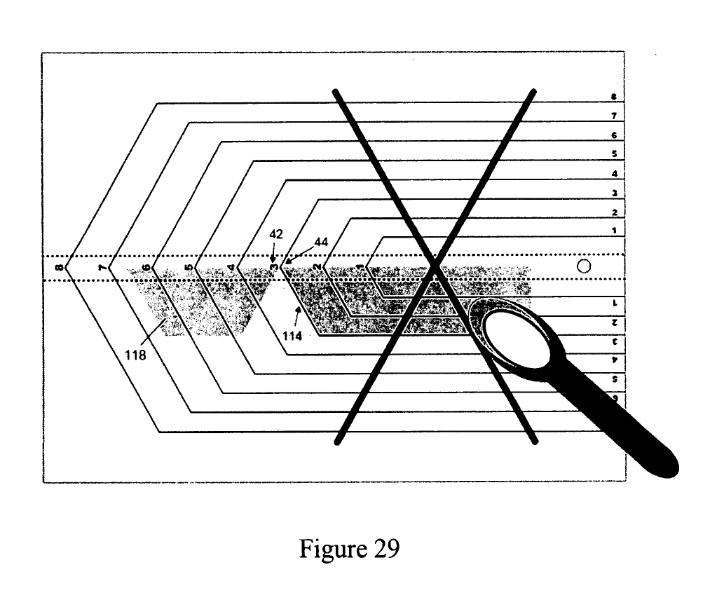

As depicted in FIG. 25, the medium is then cut with a cutting implement, such as a rotary cutter 200, by drawing the cutting implement along the groove 30. This cut produces a cut edge 114. As depicted in FIG. 26, the template is located and aligned relative to the medium so that an end of the cut edge 114 is aligned with a registration point 44. As shown in the example of FIG. 26, the cut edge 114 can be aligned with a registration point 44 having a size indicia 42 of “3,” which corresponds to the size indicia 42 of the registration line 20 that the medium has been aligned with, as shown in FIG. 24. The medium is then cut by drawing the rotary cutter 200 along both grooves 30, as depicted in FIGS. 26 and 27. These latter two cuts produce a trapezoid shape 118 and a triangular shape 116, as shown in FIG. 28. Furthermore, the cuts produce a cut edge 114 in the medium, permitting the steps of FIGS. 26 and 27 to be repeated to produce additional trapezoid shapes 118 and triangular shapes 116, as depicted in FIG. 29.

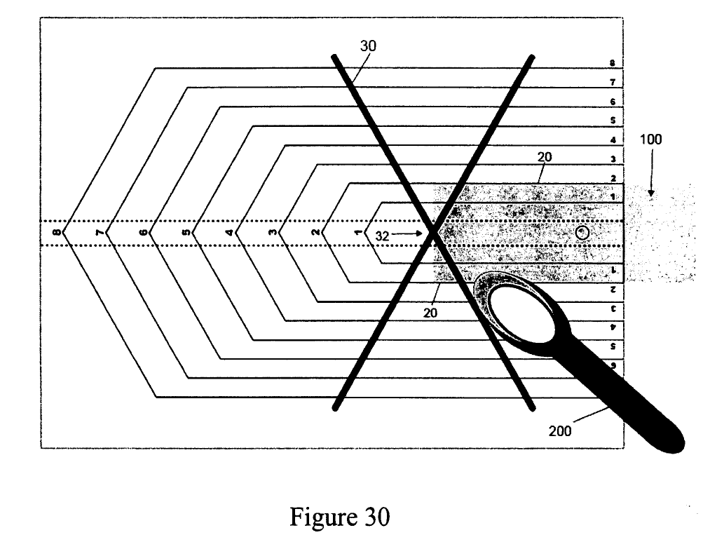

According to another embodiment, a method of cutting a gemstone is provided, as shown in the examples of FIGS. 30-35. The template depicted in FIGS. 30-35 can have any features of the template embodiments described herein. FIGS. 30-35 depict exemplary steps of cutting a gemstone from a medium 100 that is disposed underneath a template. As shown in FIG. 30, a template is initially disposed on top of a medium 100 so that the medium is located and aligned between registration lines 20 and so that a leading edge of the medium is aligned with the center 32 of the X. In the example shown in FIG. 30, the medium is arranged between registration lines 20 with “2” size indicia 42. However, medium 100 can be arranged between registration lines 20 of other size indicia 42 or between off-size registration lines 24.

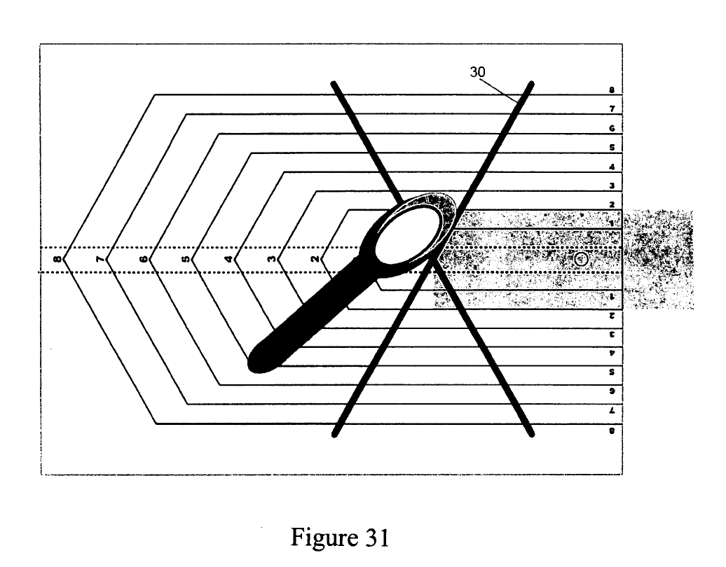

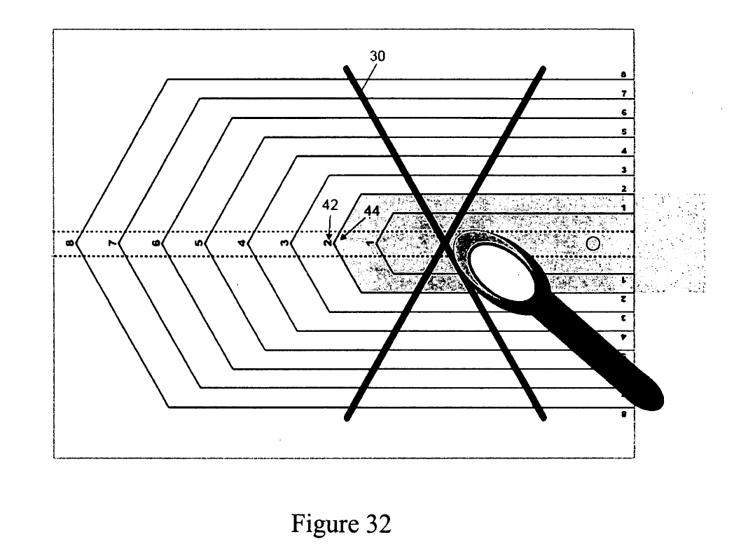

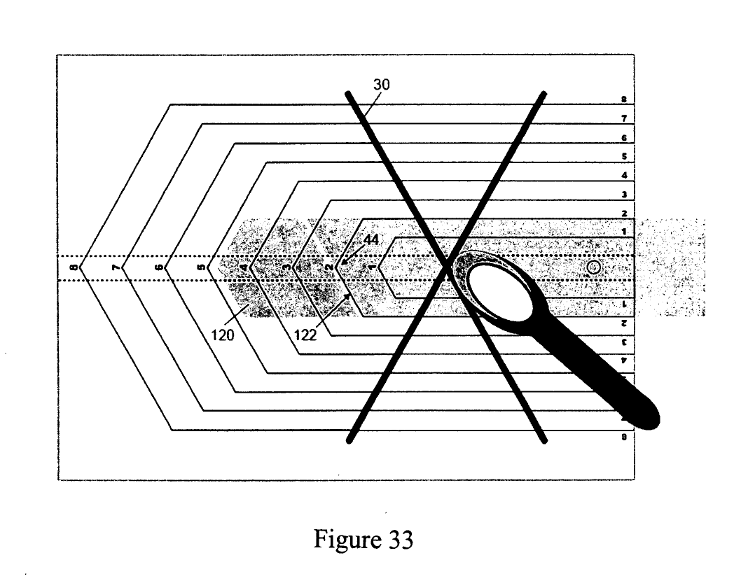

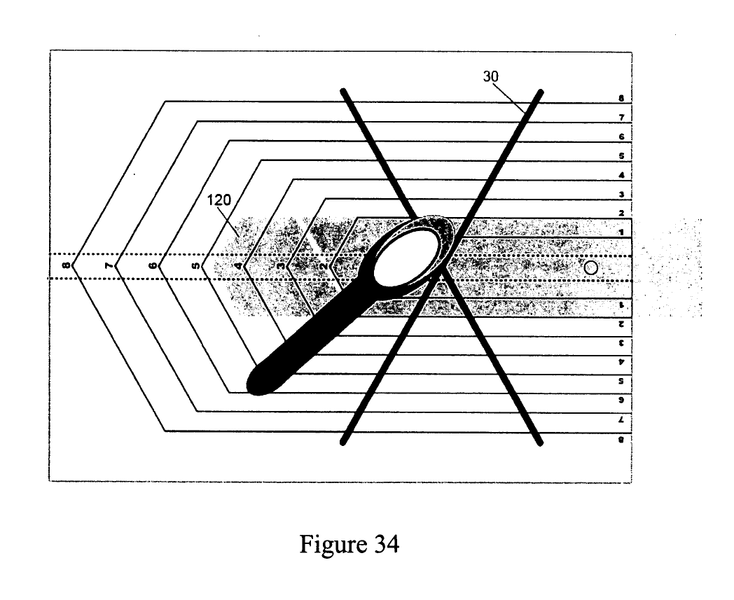

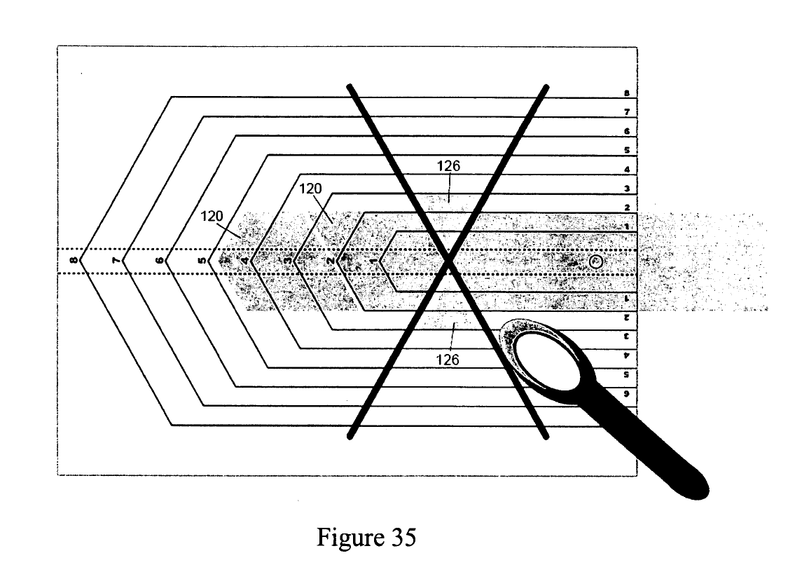

At this point, the medium 100 and template are prepared for cutting with a cutting implement, such as a rotary cutter 200. As shown in FIGS. 30 and 31, the rotary cutter 200 is drawn along both grooves 30 to provide two cuts in medium 100 that form a broad point on the left edge of the medium 100. The template is then located and aligned with the medium so that the broad point of the medium is aligned with a registration point 44. As depicted in the example of FIG. 32, the broad point can be aligned with a registration point 44 having a size indicia 42 of “2,” which corresponds to the size indicia of the registration lines 20 that the medium was aligned between in FIG. 30. The rotary cutter 200 is then drawn along one of the grooves 30, as shown in FIG. 32. This cut produces a gemstone shape 120, as depicted in. FIG. 33, and a cut edge 122 in the medium which can be aligned with the registration point 44 so that additional gemstone shapes 120 can be cut from medium. As depicted in FIGS. 33 and 34, the rotary cutter 200 is drawn along both grooves 30 to cut the medium. These cuts produce an additional gemstone shape 120 and triangular shapes 126, as shown in FIG. 35. Additional gemstone shapes 120 and triangular shapes 126 can be cut from the medium by repeating the steps of FIGS. 32-34.

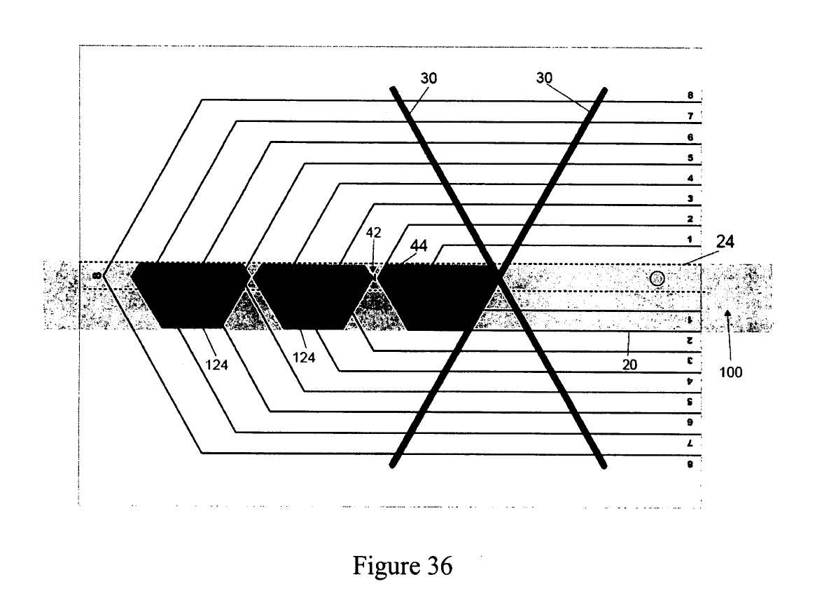

According to another embodiment, a method of cutting a polygon shape 124 is provided, as shown in the example of FIG. 36. The template depicted in FIG. 36 can have any features of the template embodiments described herein. FIG. 36 depicts exemplary steps of cutting a polygon shape 124 from a medium 100 that is disposed underneath a template. As shown in FIG. 36, a template is initially disposed on top of a medium 100 so that the medium 100 is located and aligned between an off-size registration line 24 and a registration line 20. The template is also initially aligned with the medium 100 so that an edge of the medium is aligned with the center of the X and cuts are made by drawing a cutting implement along both grooves 30. In the example shown in FIG. 36, the medium 100 is arranged between an off-size registration line 24 and a registration line 20 with “2” size indicia 42. However, a medium 100 can be arranged between registration lines 20 of other size indicia 42 or between other off-size registration lines 24.

The two initial cuts form a point on the edge of the medium and the template is aligned with the medium so that the point is aligned with a registration point 44, as depicted in FIG. 36. As shown in the example of FIG. 36, the point can be aligned with a registration point 44 having a size indicia 42 of “2,” which corresponds to the size indicia of the registration line 20 that the medium was initially aligned with. After the point is aligned with the registration point a cutting implement is drawn along both grooves 30 to produce a polygon shape 124. Additional polygon shapes 124 can be produced by repeating the steps of aligning the point cut into the medium with the registration point 44 and cutting along both grooves 30.

According to another embodiment, a template can be used to cut a medium that comprises two different mediums. For example, a material can be made of two different fabrics, such as a fabric of a first color and a fabric of a second color that are sewn together along a linear seam. According to an embodiment, a template 10 can be aligned with the linear seam so that the linear seam passes through the center 32 of the X in the template. The linear seam can also be aligned with a center line 22 of the template, as in the example of FIG. 2. A left edge of the fabric can be aligned with the center 32 of the X and cuts can be made along both grooves 30 to form a broad point, which is then aligned with a registration point 44. Cuts are then made along both grooves 30 to form a diamond shape with one half comprised of the first fabric and one half comprised of the second fabric.

According to an embodiment, a template for cutting a medium into a predetermined shape includes a flat sheet having planar first and second sides contiguous with a perimeter of said sheet, a pair of cutting grooves adapted to receive and maintain a cutting implement for cutting the medium, wherein the cutting grooves are formed in the shape of an X, and registration marks for locating said template relative to the medium, wherein the registration marks correspond to various sizes of the predetermined shape.

According to a further embodiment, the channels in the shape of an X have sufficient width to support a cutting implement for cutting the medium.

According to a further embodiment, the template is made of plastic. According to a further embodiment, the plastic is a clear plastic.

According to a further embodiment, the cutting grooves are formed in the shape of an X with 60 degrees of angle measurement for an acute angle measurement and 120 degrees of angle measurement for an obtuse angle measurement.

According to a further embodiment, the cutting grooves pass completely through the template.

According the a further embodiment, the template further comprising registration triangles for locating the template relative to a cut edge of the medium, wherein the registration triangles correspond to various sizes of the predetermined shape.

According to a further embodiment, the registration marks correspond to the length of the long axis of a hexagon.

According to a further embodiment, the registration marks correspond to the length of the long axis of a trapezoid.

According to a further embodiment, the registration marks correspond to half of the length of a side of an equilateral triangle.

According to an embodiment, a method for cutting a medium into a predetermined shape includes the steps of: (a) providing a template for cutting a medium into a predetermined shape includes a flat sheet having planar first and second sides contiguous with a perimeter of said sheet, a pair of cutting grooves adapted to receive and maintain a cutting implement for cutting the medium, wherein the cutting grooves are formed in the shape of an X, and registration marks for locating said template relative to the medium, wherein the registration marks correspond to various sizes of the predetermined shape; (b) positioning said template over or upon the medium; (c) inserting a cutting implement into one cutting groove; (d) drawing the cutting implement across the medium sufficiently to make a complete cut, transecting a cut portion from the remainder of the medium, while having lateral movement of the implement constrained by the sides of the cutting grooves in the template; (e) repeating steps C and D in the other cutting groove of the template sufficient to create a pair of cuts through the medium; (f) moving the template across the medium in a fashion parallel with the medium to a specific location based on the predetermined shape and verified through the registration marks on the template; (g) repeating steps C through F until the medium to be cut has been exhausted or enough has been cut based upon a user's needs.

According to a further embodiment, step A further comprises providing the medium in strip form.

According to a further embodiment, the predetermined shape is a hexagon. According to a further embodiment, the template further comprises registration triangles for locating the template relative to a cut edge of the medium, wherein the registration triangles correspond to various sizes of the predetermined shape; wherein step F further comprises moving the template across the medium so that the a broad point formed by the cuts made in steps C and D is aligned with a registration triangle.

According to a further embodiment, the predetermined shape is a trapezoid. According to a further embodiment, step F further comprises moving the template across the medium so that a top cut edge and a bottom cut edge of the medium are aligned with edges of the cutting groove.

According to a further embodiment, the predetermined shape is an equilateral triangle. According to a further embodiment, step E further comprises moving the template across the medium until an end of the cut is just touching the other cutting groove.

According to an embodiment, a template for cutting a medium with a sharp blade includes a flat sheet of plastic or similar material having planar first and second sides contiguous with a perimeter of said panel, said panel also having a pair of channels adapted to receive and maintain a cutting edge for cutting a material, these channels formed in the shape of an X with 60 degrees of angle measurement comprising the acute angle and 120 degrees of angle measurement comprising the obtuse angle measurement.

According to a further embodiment, the template shall have registration marks intended for locating said template relative to the medium intended to be cut.

According to a further embodiment, the channels in the shape of an X shall have sufficient width to support a blade used in cutting intended medium.

According to an embodiment, a method is providing for cutting a medium using the template of the previous embodiment, which includes the steps of: (a) providing a template in the form of a flat sheet having planar sides coextensive with a perimeter of the sheet and having a pair of channels which form an X in the template for registration of the cuts relative to the medium intended to be cut; (b) positioning said template over or upon a selected medium; (c) inserting a cutting blade into one channel insofar as to maintain contact between the blade and the medium to be cut; (d) drawing the cutting blade across the medium sufficiently to make a complete cut, transecting the cut portion from the remainder of the medium, while having lateral constraint of movement against the sides of the channels in the template; (e) repeating steps C and D in the other channel of the template sufficient to create a pair of cuts through the medium intended to be cut; (f) moving the template across the medium in a fashion parallel with the medium to a specific location based on the user's needs and verified through the registration marks on the template; (g) repeating steps C through F until the medium to be cut has been exhausted or enough has been cut based upon the user's needs.

Given the present disclosure, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A template for cutting a medium into a predetermined shape comprising:
a sheet;
a pair of cutting grooves adapted to receive and maintain a cutting implement for cutting the medium, wherein the cutting grooves are formed in the shape of an X; and
registration marks for locating said template relative to the medium;
wherein the cutting grooves each have a width sufficient to restrict lateral movement of the cutting implement within the grooves.

2. The template of claim 1, wherein the template is transparent or translucent.

3. The template of claim 1, wherein the template is comprised of a plastic material.

4. The template of claim 1, wherein the cutting grooves form the shape of an X by forming two acute angles of 60 degrees in angle measurement and two obtuse angles of 120 degrees in angle measurement between the cutting grooves.

5. The template of claim 1, wherein the template is arranged to cut fractional sizes of the predetermined shape, wherein the fractional sizes do not correspond to the various sizes of the predetermined shape that correspond to the registration marks.

6. The template of claim 1, wherein the registration marks comprise registration points for locating the template relative to a cut edge of the medium, wherein the registration points correspond to various sizes of the predetermined shape.

7. The template of claim 1, wherein the registration marks correspond to the length of a long axis of the predetermined shape.

8. The template of claim 1, wherein the registration marks are arranged at a calibrated distance from a center of the X, wherein the calibrated distance corresponds to a size of the predetermined shape.

9. The template of claim 1, wherein the registration marks comprise registration lines arranged in pairs symmetrically disposed about a center of the X.

10. A method for cutting a medium into a predetermined shape, comprising:
a. providing the template of claim 1;
b. positioning said template over or upon the medium;
c. inserting a cutting implement into one cutting groove;
d. drawing the cutting implement across the medium sufficiently to make a complete cut; and
e. repeating steps C and D or repositioning said template relative to the medium before repeating steps C and D.

11. The method of claim 10, wherein step A further comprises providing the medium in strip form.

12. The method of claim 10, wherein the predetermined shape is a hexagon.

13. The method of claim 10, wherein the predetermined shape is a triangle.

14. The method of claim 10, wherein the predetermined shape is a diamond.

15. The method of claim 10, wherein the predetermined shape is a trapezoid.

16. The method of claim 10, wherein the predetermined shape is a gemstone.

17. A template for cutting a medium into a predetermined shape comprising:
a sheet;
a pair of cutting grooves adapted to receive and maintain a cutting implement for cutting the medium, wherein the cutting grooves are formed in the shape of an X; and
registration marks for locating said template relative to the medium;
wherein the registration marks are arranged at a calibrated distance from a center of the X, wherein the calibrated distance corresponds to a size of the predetermined shape.

18. The template of claim 17, wherein the cutting grooves form the shape of an X by forming two acute angles of 60 degrees in angle measurement and two obtuse angles of 120 degrees in angle measurement between the cutting grooves.

19. The template of claim 17, wherein the registration marks comprise registration lines arranged in pairs symmetrically disposed about a center of the X.

20. The template of claim 1, wherein the cutting grooves each have a width such that, when the cutting implement is in one of the cutting grooves, the cutting implement can move only in a forward-rearward direction and not in a lateral direction.

21. The template of claim 1, wherein the template is configured to cut multiple layers of medium at once.
